(19) United States
(12) Patent Application Publication
(10) Pub. No.: US 2011/0172858 A1
(43) Pub. Date: Jul. 14, 2011

(54) JOYSTICK CONTROLLED MARINE MANEUVERING SYSTEM

(75) Inventors: Dave Gustin, Seattle, WA (US); Ben Triplett, Seattle, WA (US); Carlos Gonzalez, Seattle, WA (US); Jose Contreras, Everett, WA (US)

(73) Assignee: ZF FRIEDRICHSHAFEN AG, Friedrichshafen (DE)

(21) Appl. No.: 13/057,532

(22) PCT Filed: Oct. 1, 2009
(86) PCT No.: PCT/US09/59222

§ 371 Date: Mar. 29, 2011

Related U.S. Application Data
(60) Provisional application No. 61/102,167, filed on Oct. 2, 2008.

(51) Int. Cl. G06F 17/00

(52) U.S. Cl. 701/21

(57) ABSTRACT

A marine propulsion and steering system for a vessel having multiple modes of operation, an axial propulsion system, a maneuvering propulsion system and a maneuvering control system including a pilot controllable joystick for generating propulsion and maneuvering control inputs representing vessel motions desired by a pilot. An input loop is responsive to the joystick control inputs to generate maneuvering commands representing the magnitudes and directions of motions of the vessel desired by the pilot and the actuator loop controller is responsive to the maneuvering commands from the input loop to generate corresponding vessel control commands to the vessel propulsion and maneuvering systems.

### FIELD OF THE INVENTION

The present invention relates to a joystick controlled maneuvering system for a ship and, in particular, to a joystick maneuvering controller having an input loop transforming user joystick maneuvering inputs into corresponding ship maneuvering commands and an actuator loop transforming the ship maneuvering commands into corresponding ship controller and propulsion system command inputs.

### BACKGROUND OF THE INVENTION

Marine craft of a wide range of sizes and functions require the capability for precisely controlled navigation in confined or restricted waters, including and ranging from, for example, pleasure craft, fishing and work vessels such as tugs, various harbor craft, survey, salvage, supply and marine work vessels, cruise ships and ferries visiting small harbors, fjords, estuaries or other confined regions of interest, to larger vessels who find themselves in effectively confined waters due to their size and/or draft, such as larger cruise or passenger vessels, tankers, freighters, drilling rigs and platforms, and so on. Such vessels thereby often require the capability for precisely controllable translational movement, that is, straight line movement, and precisely controllable rotation about a fixed axis extending vertically through a centerline of the vessel.

These requirements are typically and commonly met by maneuvering and propulsion systems that include a conventional propulsion and navigation system comprised of one or more steerable rudders and one or more independently controllable propellers in combination with a maneuvering system that includes one or more fixed or steerable thrusters comprised, for example, of pumps or ducted propellers.

Such combined propulsion and maneuvering systems, however, suffer from a number of disadvantages and problems, one of the most common and persistent of which is that each such system is typically unique as regards both its own characteristics and the maneuvering characteristics of the vessel itself when controlled by such a system. As a consequence, each person that is to pilot a vessel equipped with such a propulsion and maneuvering system is required to individually learn and extensively practice with the vessel and the propulsion and maneuvering system in order to learn the individual and unique handling characteristics of both the propulsion and maneuvering system and the vessel to a level necessary for safe navigation of the vessel. These problems are compounded in that each propulsion system, such as the main engines, the rudders, and bow and stern thrusters, each has its own independent user interface. In addition, the knowledge and experience gained by a person with one vessel and propulsion and maneuvering system is, at best, only partially transferrable to a different vessel and propulsion and maneuvering system, so that each new vessel and propulsion and maneuvering system must essentially be learned anew from the beginning.

It must also be noted that the characteristics of a vessel and its propulsion and maneuvering system must be individually determined when, for example, the vessel and propulsion and maneuvering system is first built and put into service or when such a propulsion and maneuvering system is added to an existing vessel. This process must thereafter be repeated whenever there has been any significant change or modification, to either the vessel or the propulsion and maneuvering system, that might effect the handling characteristics of either the vessel or the propulsion and maneuvering system.

The determination of the handling characteristics of a new or modified vessel or propulsion and maneuvering system, however, is a lengthy and expensive process, such as the “bollard” tests performed for automatic control systems. In a bollard test for an automatic control system the vessel is secured moored to an arrangement of fixed bollards and the forces exerted by the vessel on the moorings is measured while the vessel and propulsion and maneuvering system are exercised throughout the entire range of their maneuvering and propulsion capabilities. In general, the probable handling characteristics of the vessel and propulsion and maneuvering system are calculated from the measurements and the physical parameters of the vessel and propulsion and maneuvering system, such as vessel dimensions, windage, mass and so forth, with the calculated responses of the vessel.

It will be apparent, however, that the calculated handling characteristics of the vessel and propulsion and maneuvering system may not accurately or even adequately represent the actual handling characteristics of the vessel or propulsion and maneuvering system, particularly under actual operating conditions, such as wind and current effects or the effects of vessel loading. The actual handling characteristics of the vessel and the propulsion and maneuvering system are, therefore, not known to the desired level of confidence until sufficient actual experience with the vessel and propulsion and maneuvering system has been acquired under actual operating conditions. It will also be appreciated that a person intended to pilot the vessel cannot learn the handling characteristics of the vessel or propulsion and maneuvering system from calculated characteristics and must, again, learn such matters for each vessel and propulsion and maneuvering system by actual experience with the vessel and propulsion and maneuvering system.

The present invention provides a solution to these and related problems of the prior art.

### SUMMARY OF THE INVENTION

The present invention is directed to a marine propulsion and steering system for a vessel having multiple modes of operation and including a vessel propulsion system including an axial propulsion system including at least one engine for controlling axial motion of the vessel, a maneuvering propulsion system including at least one controllable thruster for controlling rotational and translational motion of the vessel, and a maneuvering system.

The maneuvering system includes at least one pilot controllable joystick for generating propulsion and maneuvering control inputs representing vessel motions desired by a pilot and a maneuvering processor including an input loop controller and an actuator loop controller responsive to the pilot joystick control input for generating corresponding control outputs to the at least one thruster and to the at least one engine to control the translational and rotational motions of the vessel in compliance with the joystick control inputs.

The input loop controller is responsive to the joystick control inputs to generate maneuvering commands representing the magnitudes and directions of forces of the vessel desired by the pilot and the actuator loop controller is responsive to the maneuvering commands from the input loop controller to generate corresponding vessel control commands to the vessel propulsion system to generate propulsion and maneuvering forces to cause the vessel to move in compliance with the joystick input commands.

The present invention is further directed to a method for controlling a vessel propulsion system including a joystick control wherein motion of the joystick about an axis of motion of the joystick provides a corresponding motion control command to the vessel propulsion system, an axial propulsion system including at least a first engine for controlling axial motion of the vessel and at least one of a rudder, for controlling a direction of motion of the vessel, a second engine, for controlling axial and directional motion of the vessel, and a maneuvering propulsion system including at least one manipulatable and/or controllable thruster for controlling rotational and translational motion of the vessel.

According to the present invention, the operator selects a mode of operation from at least one of a normal mode of operation, a hold bearing mode of operation, a hold position mode of operation and a combined hold bearing and hold position mode of operation. When in the normal mode of operation, all heading, axial motion, rotation and lateral motion of the vessel is controlled by a joystick control input by corresponding joystick control inputs. When in the hold bearing mode of operation, the system holds constant a current bearing of the vessel and controls axial and lateral motion of the vessel by corresponding joystick inputs. When in the hold position mode of operation, the system holds constant the current vessel position, to the best ability of the vessel actuators and when in the combined hold bearing and hold position mode of operation, the system holds constant a current vessel bearing and position.

In another implementation of method for controlling a vessel propulsion system the system includes at least one of a basic propulsion mode of operation, a maneuvering mode of operation and a drive mode of operation. In the basic propulsion mode of operation, vessel axial motion commands are generated upon corresponding motions of the joystick and vessel rotation commands are generated upon corresponding rotational motions of the joystick and the system is commanded to enter the maneuvering mode of operation by a lateral motion of the joystick or the drive mode of operation when a motion of the joystick generating axial motion commands exceeds a drive mode set point. In the maneuvering mode of operation, vessel lateral motion commands are generated by corresponding lateral motions of the joystick and vessel axial motion commands are generated by corresponding motions of the joystick that exceeding a drive mode set point. In the drive mode of operation, vessel axial motion commands are generated by corresponding motions of the joystick and at least one of rudder steering commands and first and second engine steering commands are generated upon corresponding lateral motions of the joystick.

The term “steerable”, as used herein in connection with thrusters, means that the thruster can generate a steering force in at least two opposed directions.

### DESCRIPTION OF THE DRAWINGS

The above discussed aspects of the prior art and the following discussed aspects of the present invention are illustrated in the figures, wherein:

FIGS. 1A-1J are diagrammatic illustrations of the types and range of translational and rotational motions that may be achieved by a propulsion and maneuvering system of the present invention;

FIGS. 2A and 2B are respectively a block diagram of an exemplary joystick controlled propulsion maneuvering system of the present invention and an general diagrammatic representation of an exemplary joystick controlled maneuvering system of the joystick controlled propulsion maneuvering system; and,

FIGS. 3A, 3B, 3C and 3D are block diagrams of a control system of a propulsion and maneuvering system.

### DESCRIPTION OF THE INVENTION

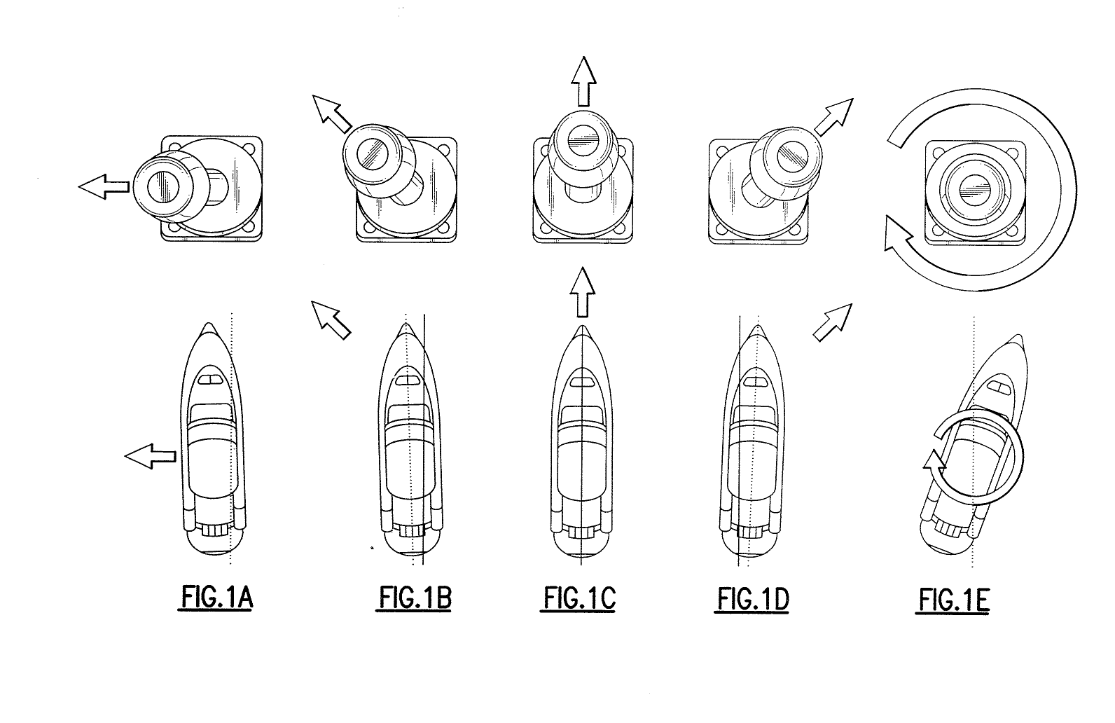

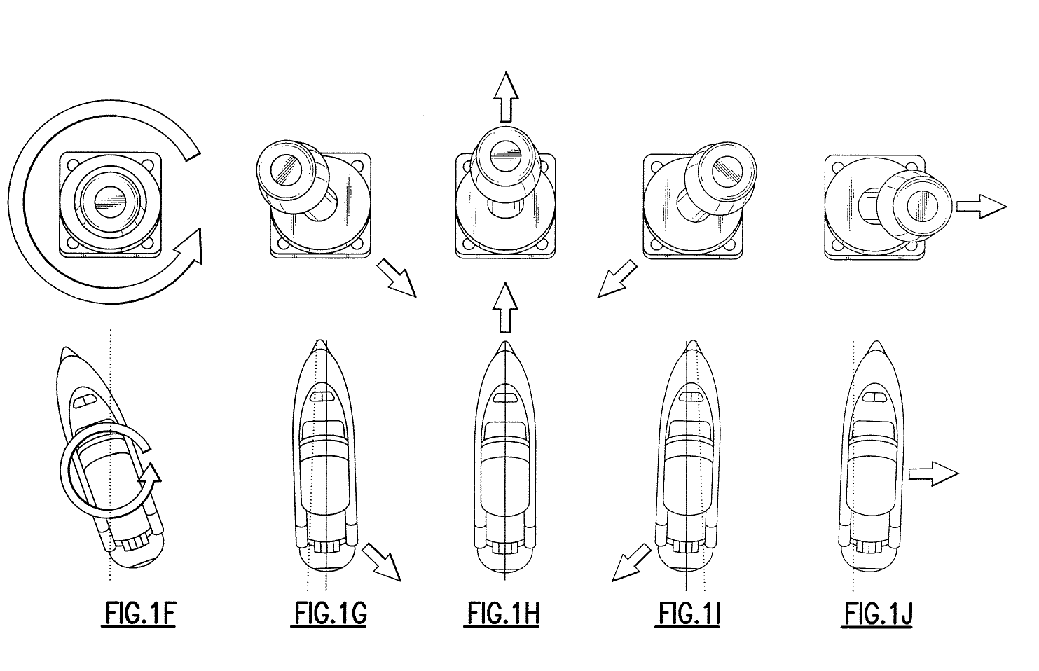

Referring to FIGS. 1A-1J, therein are presented diagrammatic illustrations of exemplary types and ranges of translational and rotational vessel motion that are to be achieved by a joystick controlled propulsion and maneuvering system of the present invention wherein each of FIGS. 1A-1J illustrates a position or motion of joystick 1 and the corresponding translational or rotational motion of the vessel 2. As shown, the motions of joystick 1 include tilt in the forward, back, right and left directions and combinations therefore, such as a tilt forward to the right or back to the left, and rotation about the vertical axis of joystick 1, which can be combined with tilt motions of joystick 1. The corresponding motions of vessel 2 as controlled by movements of joystick 1 include translational movements in four basic directions, including forward axial motion (FIG. 1C), reverse axial motion (FIG. 1H), port lateral motion (FIG. 1A), starboard lateral motion (FIG. 1J), and rotational movement about vertical center axis 3 of vessel 2, including rightward rotation (FIG. 1E), and leftward rotation (FIG. 1F). It is to be appreciated that the joystick manipulations, shown in FIGS. B, D, G and I, can be invoke either with or without bearing hold, and the bearing hold feature is discussed below in further detail.

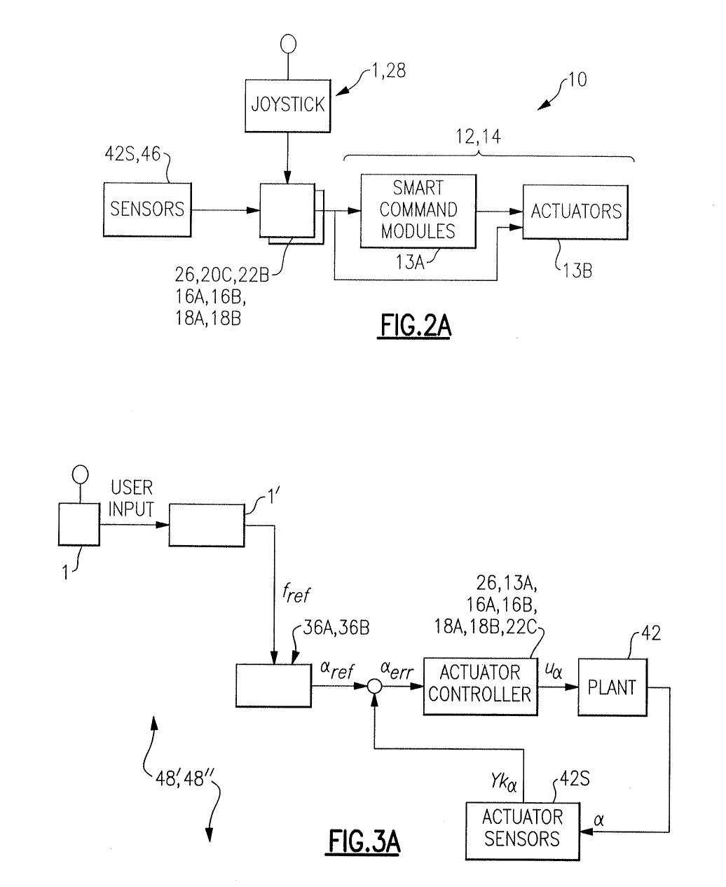

Referring to FIGS. 2A and 2B, therein are respectively shown a detailed block diagram of an exemplary joystick controlled propulsion maneuvering system 10 of the present invention that includes a propulsion and steering system 12 for conventional propulsion and steering of the vessel 2 and a maneuvering system 14 for controlling translational and rotational maneuvering of the vessel 2, and an generalized block diagram of the maneuvering system 14.

As indicated in FIGS. 2A and 2B, the actuators 13B of a propulsion maneuvering system 10 may include, for example, engines, thrusters and rudders which are controlled directly by outputs of a maneuvering processor 26 or indirectly through one or more actuator control units 13A. The actuators 13B and the actuator control units 13A are, in turn and for example, controlled by the outputs of a maneuvering processor 26 and by outputs of, for example, engine controllers 16C and 16D and propulsion processors 18A. Command inputs of maneuvering processor 26 of the propulsion maneuvering system 10 are in turn provided by joysticks 1, which are represented in FIG. 2B as joysticks 1A-1X one or more control stations 28A-28x, which also receives inputs from navigational sensors 46 and propulsion unit sensors 42S. Other command inputs of individual actuators 13B of the propulsion maneuvering system 10 may be provided by command outputs from a steering control stick or wheel 22B and/or one or more control heads 20C and, as described in detail below, by command outputs from maneuvering processor 26.

It will therefore be recognized from the above discussion and from the following detailed descriptions that, because maneuvering processor 26 of propulsion maneuvering system 10 provides control inputs to propulsion processor 18A and 18B of the propulsion and steering system 12, the propulsion maneuvering system 10 may be considered as incorporating the control and propulsion elements of a conventional propulsion and steering system that may be present in the vessel, such as engine controllers 16C and 16D and propulsion processors 18A and 18B and thereby engines 16A and 16B and rudder 22A, although the rudders are not absolutely required.

Therefore next considering the exemplary joystick controlled joystick controlled propulsion maneuvering system 10 illustrated in FIG. 2A in further detail, the actuators 13B will typically, and for example, include one or more individually controllable engines 16A and 16B and one or more rudders 22A. As illustrated in FIG. 2B, control inputs for engines 16A and 16B and rudder or rudders 22A may typically be provided, for example, through propulsion controllers 20A and 20B of a control head 20C and a steering wheel or steering control stick 22B. The engines 16A and 16B and the rudder or rudders 22A may each be controlled directly through local engine controllers 16C and 16D as indicated in FIG. 2B, or indirectly through corresponding command/control units 13A, examples of which may include propulsion processors 18A and 18B and a steering control processor 22C, again as indicated in FIG. 2B.

The actuators 13B will, in a typical and presently preferred embodiment, include one or more thrusters 24, such as bow and stern thrusters 24A and 24B, which are controlled through maneuvering processor 26 by one or more joysticks 1, shown in FIG. 2A as joysticks 1A-1x, and thrusters 24 may be controlled directly or indirectly through corresponding command/control units 13A. As described briefly above and in detail in following discussions, propulsion maneuvering system 10 may be considered as incorporating, for example, the engine controllers 16C and 16D and propulsion processors 18A and 18B and thereby engines 16A and 16B and rudder 22A, as well as thrusters 24. Propulsion maneuvering system 10 thereby allows the maneuvering of the vessel 2 to be controlled from any one of a plurality of control stations 28A-28x, which in a presently preferred embodiment may be comprised of joystick control stations.

As described above, the propulsion maneuvering system 10 generates control outputs to an engine 16A and a rudder 22A or engines 16A and 16B and rudders 22A to control the axial, that is, forward and reverse, motion of the vessel 2 and the heading of the vessel 2 in a conventional manner. Propulsion maneuvering system 10, as also shown in FIG. 2 and described above, generates control outputs to thrusters 24 and to propulsion processors 18A and 18B and thereby to engines 16 and rudders 22A. Propulsion maneuvering system 10 therefore controls both the translational and rotational motion of the vessel 2 as well as the heading of the vessel 2, in accordance with FIGS. 1A-1J.

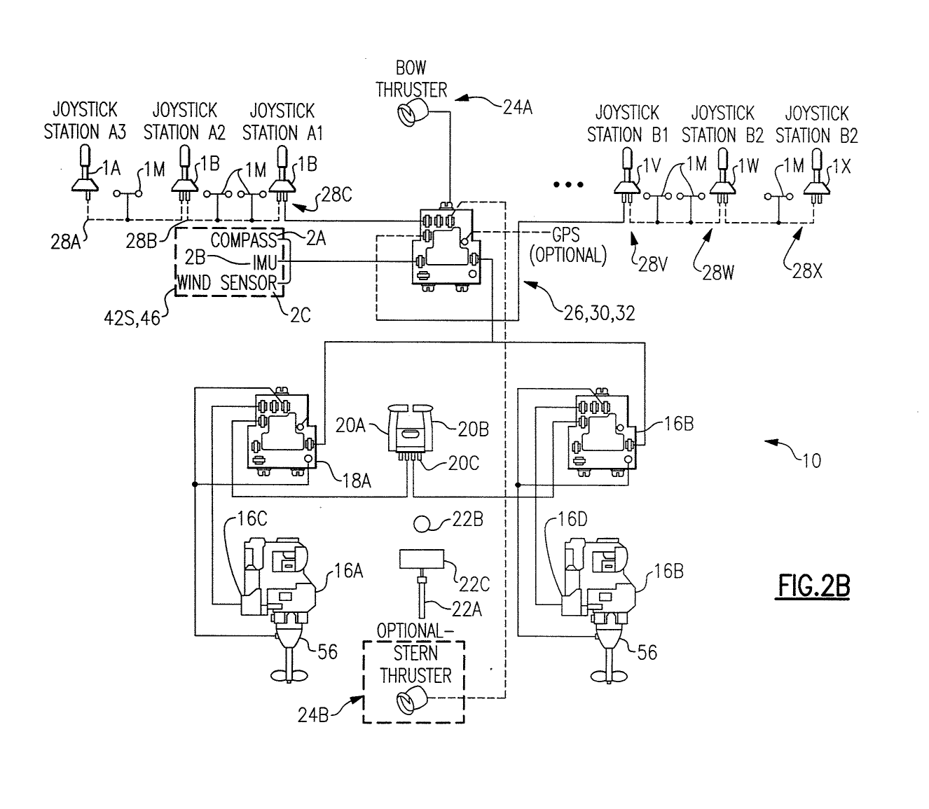

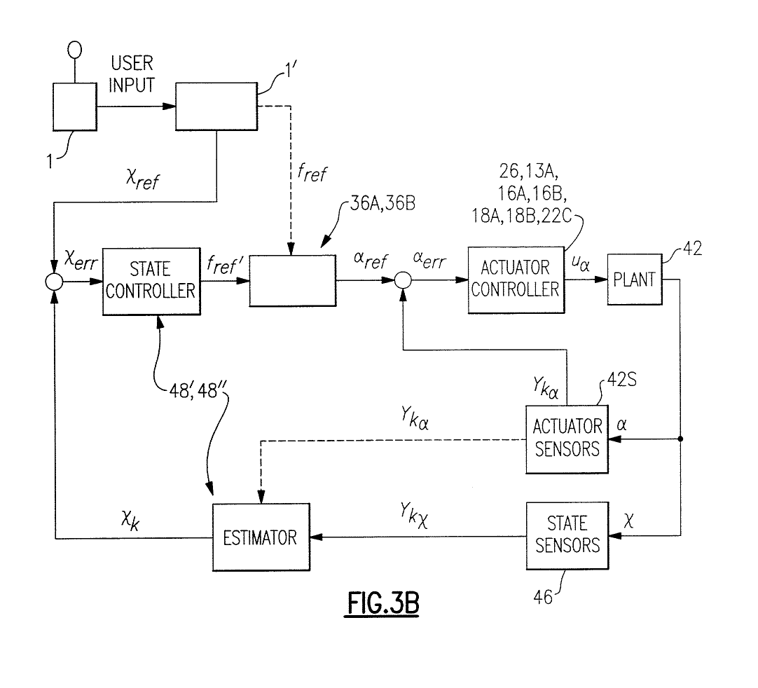

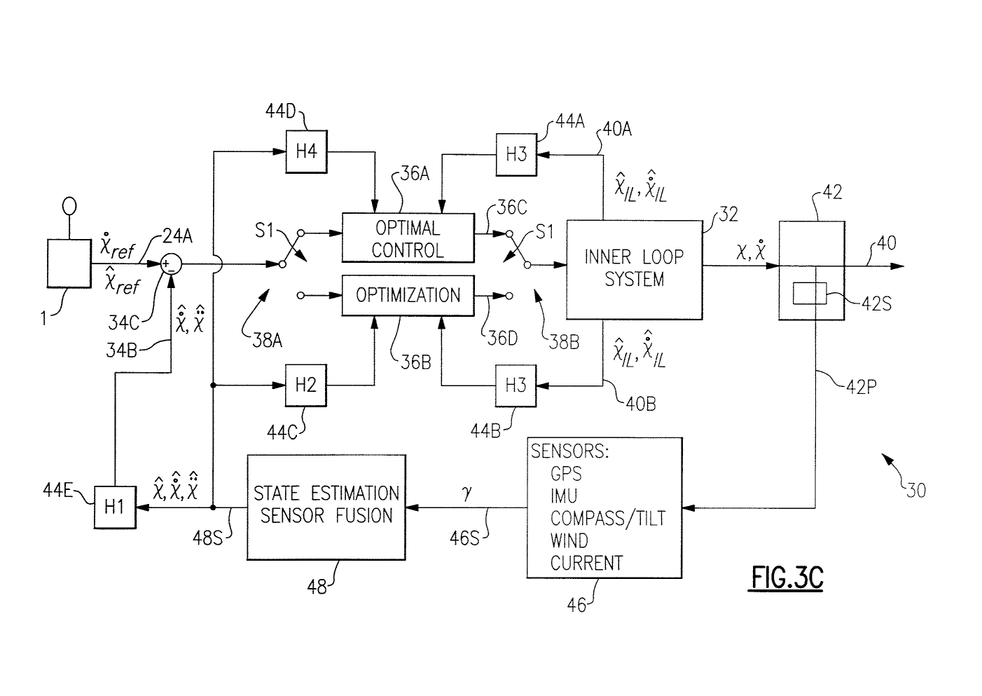

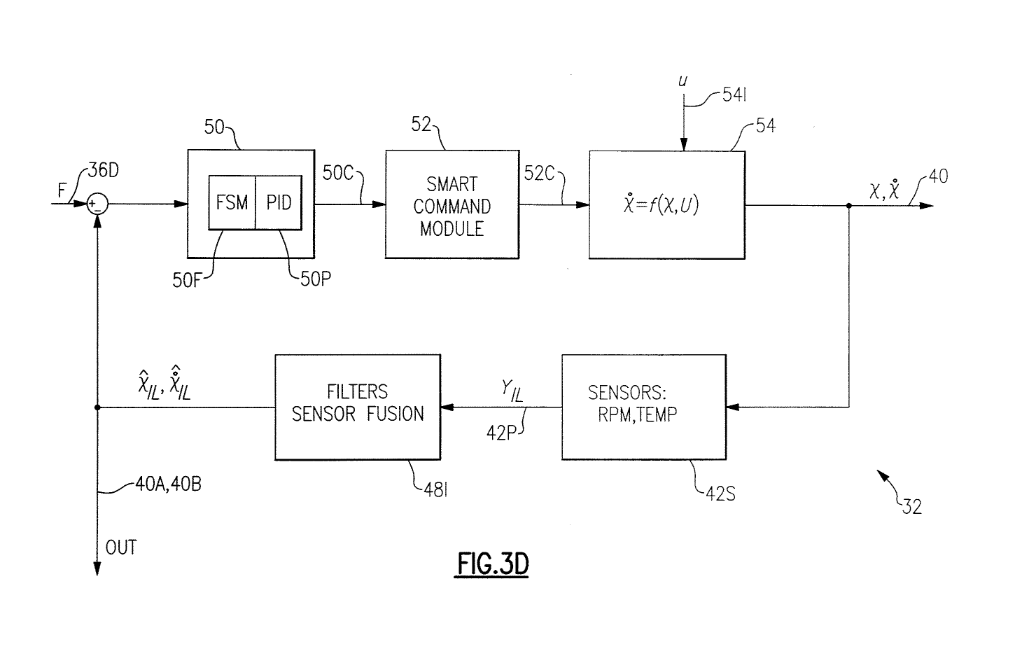

As will be described in detail in the following discussions, and in particular with regard to FIG. 3, propulsion maneuvering system 10 includes a input loop 30 and an actuator loop 32 which are implemented and embodied in maneuvering processor 26 and which generate the control outputs to thrusters 24 and to propulsion processors 18A and 18B to control the motion of vessel 2 in compliance with a pilot's inputs through a joystick 1.

As described in detail in the following, the input loop 30 receives a pilot's inputs from a joystick 1 representing vessel motions desired by the pilot and generates maneuvering commands representing the magnitudes and directions of the vessel motions desired by the pilot. The actuator loop 32, in turn, translates the maneuvering commands from the input loop 30 into control signals to the thrusters 24, the engines 16 and the rudders 22A to control these elements to generate the forces necessary for the vessel 2 to follow the pilot's input commands.

Stated another way, the input loop 30 interfaces with the pilot of the vessel 2 and operates in a vessel motion control space that is independent from and separate from the actual physical and functional characteristics and parameter of the vessel 2 and, for example, thrusters 24, engines 16 and rudders 22A, and is instead defined by the vessel axial, translational and rotational motions desired by the pilot as expressed through the joystick 1. The actuator loop 32, in turn, interfaces with and operates in a control space that is defined by and includes the actual physical and functional characteristics and parameters of thrusters 24, engines 16 and rudders 22A and the actual physical characteristics and parameters of vessel 2, including such factors as vessel 2 mass and dimensions and the effects of wind and currents. In summary, therefore, the input loop 30 translates a pilot's desires as regards vessel maneuvering into abstract values of vessel position, and/or acceleration and/or velocity while the actuator loop 32 translates the abstractly expressed values for desired vessel position, acceleration and velocity into the corresponding commands to thrusters 24, engines 16 and rudders 22A necessary to achieve the desired results.

Before considering propulsion and steering system 12 and maneuvering system 14 with the input loop 30 and the actuator loop 32 in further detail, it should first be noted that a presently preferred embodiment of a joystick controlled propulsion and maneuvering system 10 may implement and embody one or more a number of operating modes and that the embodied operating modes may be selectable according to circumstances and requirements.

For example, possible operating modes of the propulsion and steering system 12 and maneuvering system 14 may implement either or both or neither of two basic command modes, referred to hereafter as the force command mode and the rate command mode, with the capability of selecting the basic command mode preferable in the existing circumstances or according to the operators preferences. In the force command mode the pilot's joystick control inputs are translated into commands controlling the acceleration of the vessel 2 and in the rate command mode the pilot's joystick control inputs are translated into commands controlling the velocity of the vessel 2. In a presently preferred embodiment of a joystick controlled propulsion and maneuvering system 10 the pilot may select between these command modes as desired and according, for example, the method the pilot feels most comfortable with or the method the pilot feels is most appropriate for a given set of circumstances.

Considering examples of propulsion and maneuvering system 10 joystick controlled propulsion and maneuvering system 10 operating methods that may be implemented using either or both of the above two basic command modes, a first operating method for a joystick controlled propulsion and maneuvering system 10 may include, for example, one or more of:
(A) A normal mode in which the pilot's joystick 1 inputs control all motions of the vessel 2, including vessel heading, vessel axial velocity or acceleration, and vessel rotation and direction of lateral acceleration or velocity.
(B) A hold bearing mode in which the current bearing of the vessel 2 are held constant while the joystick 1 inputs control the axial and lateral velocity and acceleration of the vessel 2.
(C) A hold position mode in which the system holds constant, to the best ability of the vessel actuators, the current vessel position, e.g., the axial and lateral acceleration and velocity of the vessel 2 are held constant so that the vessel 2 remains at a fixed position while the joystick 1 inputs control the bearing of the vessel.
(D) A combined hold bearing and hold position mode in which the vessel 2 bearing, rotation and position are all held constant.

A second operating method for a joystick controlled propulsion and maneuvering system 10 may include, for example, one or more of:
(A) A basic propulsion mode, which comprises the default mode of operation and in which forward and backward motion (tilt) of the joystick that exceeds a drive mode set point generates vessel forward and backward axial motion of the vessel at slow speed while rotation, that is, twisting, of the joystick, generates rotational motion commands for the vessel to turn or rotate about its center point. Sideways motion (tilt) of the joystick, however, generates a command for the system to be switched to the maneuvering mode of operation, described next below.
(B) The maneuvering mode in which sideways (tilt) motion of the joystick generates commands for lateral motion of the vessel. It must be noted that the maneuvering mode of operation would be unavailable, or locked out, if the lateral thruster or thrusters, which cause and control sideways motion of the vessel, is unavailable or if the operator locks out the maneuvering mode. It should also be noted that while the vessel is maneuvering in the maneuvering mode forward or backward motion (tilt) of the joystick past the drive mode set point typically does not result in the system being switched to the drive mode, described next below. In certain embodiments, however, the system may switch from the maneuvering mode to the drive mode if the forward or backward (tilt) motion of the joystick exceeds the drive mode set point or some other desired set point.
(C) The drive mode is entered when the system is in the basic propulsion mode of operation and when the forward or backward motion (tilt) of the joystick exceeds the drive mode threshold, with the system reverting to the basic propulsion mode if the forward or backward motion (tilt) of the joystick falls below the drive mode threshold. When in the drive mode, the vessel moves forward or backwards as directed by the forward or backward motion (tilt) of the joystick and, if rudder steering is available, the sideways motion (tilt) of the joystick is interpreted as steering command inputs to control the yaw of the vessel. If rudder steering is not available when in the drive mode, the sideways motion (tilt) of the joystick is interpreted as engine commands to control the yaw of the vessel. The thruster and thus sideways motion of the vessel are not available in the drive mode.

It must be noted that a propulsion and maneuvering system 10 may be implemented with any subset of the respective described modes of operation of the first and second methods of operation, or with any combination or subset of modes of operation selected from the first and second methods of operation. For example, a propulsion and maneuvering system 10 may be implemented with only the basic propulsion and drive modes of the second operating method if the vessel is not equipped with lateral thrusters or controllable rudders or the maneuvering mode may be locked out under certain operating conditions wherein lateral maneuvering would be undesirable.

A joystick controlled propulsion and maneuvering system 10 embodying either or both of the above described operating methods will typically also include an optical indicator indicating to the operator the mode in which the system 10 is currently operating, that is, whether the system 10 is operating in the normal, hold bearing, hold position or combined hold bearing and position mode or the basic propulsion, maneuvering or drive mode. For example, the system may include an operating mode indicator 1M comprised, for example, of a red light emitting diode (LED) and a green LED and, in the second operating method, for example, operation in the basic propulsion mode may be indicated by a continuously illumination of the green LED and operation in the maneuvering mode indicated by flashing of the green LED. Operation in the drive mode may then be indicated by continuous illumination of the red LED with a warning that the rudder is not centered being indicated in the drive mode by flashing of the red LED. It will be appreciated that similar light code indications may be assigned to the various modes of operation in the first method of operation, wherein the operating modes include the normal, hold bearing, hold position or combined hold bearing and position modes.

It will be appreciated that the degree to which the above discussed command methods and modes of operation may be fully implemented will be at least in part dependent upon the availability and installation of certain sensors to detect vessel position, orientation and motion. For example, the sensors useful for the normal mode of operation may include, for example, bearing sensors, velocity and acceleration sensors, wind speed sensors, inertial measurement sensors, and so on. The hold position mode of operation may additionally require, for example, a GPS (global positioning system) or other suitably accurate position location systems.

It should also be noted that a joystick controlled propulsion and maneuvering system 10 may further include safety devices to prevent, for example, undesired or unsafe motions of the vessel, such as collisions with other vessels or surrounding structures or involvement with navigational hazards, or accidents involving, for example, persons in the water, small boats, marine life, and even structures of various types. For example, a joystick controlled propulsion and maneuvering system 10 may include a safety cut-off feature to shut down the thrusters or engines upon release of the joystick during normal mode of operation, this condition being so interpreted as commanding zero thrust rather than zero acceleration or velocity. When operating in a hold mode, for example, the neutral joystick safety cut-off may be replaced or overridden by, for example, a thruster and/or engine kill switch.

A joystick controlled propulsion and maneuvering system 10 of the present invention has been described above as comprising the input loop 30 that interfaces with the pilot of the vessel 2 and operates in a vessel motion control space that is independent from and separate from the actual physical characteristics and motion of the vessel 2 and the actuator loop 32 that interfaces with and operates in a control space that is defined by and includes the characteristics and reactions of the physical vessel 2.

Referring to FIGS. 3A, 3B and 3C, therein are shown block diagrams of the joystick control system of the present invention, a block diagram of the input loop 30 of the control system, and a block diagram of the actuator loop 32 of the control system wherein FIGS. 3A and 3C illustrate the basic joystick control system while FIG. 3B illustrates optional control, measurement and estimation signals and circuit or functions that may be added to the elements illustrated in FIG. 3A.

First referring to FIGS. 3A and 3B, and as described herein previously, as user provides command inputs indicating the desired maneuvers of the vessel 2 in the currently selected mode of operation through joystick or joysticks 1, whose inputs are interpreted by interpretation processor 1′ to generate inputs to the control system. Inputs, f_{ref} and x_{ref} are reference base values related to desired vessel maneuver relative to the current vessel condition and for the current mode of operation and may be generally expressed as desired vessel maneuver parameters, such as speed, acceleration, force or position. As indicated in FIG. 3A, reference base values x_{ref} are compared with feedback values xₖ, which are either measured or estimated state values corresponding to the actual vessel states x and representing the actual current maneuvers of the vessel, such as speed and position, and possibly acceleration and/or force, to determine error values xₑᵣᵣ representing the difference or error between the desired vessel maneuvers and the actual vessel maneuvers.

A state processor 48′ processes the values of xₑᵣᵣ to generate maneuver parameter values f_{ref}′ representing the desired maneuver parameters under the current mode of operation, and this information together with the desired maneuver parameters f_{ref} are provided to an optimal processor 36A, 36B, which determines the appropriate commands to the vessel propellers, rudders and thrusters to bring the measured actual vessel maneuver parameters into correspondence with the desired vessel maneuver parameters and generates corresponding command outputs to actuators 13B, actuator controllers 13A and vessel propulsion system 42 wherein, as discussed above, actuators 13B may include thrusters 24, engines 16 and rudders 22A. The outputs of optimal processor 36A, 36B and the outputs yₖₐ of the actuator sensors 42S, which may include, for example, shaft rpm sensors, angular position sensors and hydraulic fluid or oil temperature sensors, water flow rate and pressure sensors, and so on, to generate error signals αₑᵣᵣ indicating a difference between commanded and actual propulsion plant 42 operating states which, in turn, control actuators 13B, actuator controllers 13A and vessel propulsion system 42 so that the commanded and actual outputs and states of operation of propulsion plant 42 correspond.

As also shown, outputs yₖₐ of actuator sensors 42S and of navigational sensors 46, which, for example, may include a GPS (global positioning system) unit, an inertial navigation unit, a compass, tilt sensors, accelerometers, and so on, and which measure and indicate the navigational parameters or vectors of the vessel 2, such as vessel orientation and heading, vessel axial and lateral speeds, vessel axial and lateral accelerations, and so on, are provided to a state estimator processor 48″. The state estimator processor 48″, in turn, generates navigational feedback parameters xₖ resulting from desired vessel parameters f_{ref} and represent the actual current maneuvers of the vessel, again such as speed, acceleration, force or position, as described above.

Next considering the input loop 30 in further detail, and referring to FIG. 3C, the input loop 30 effectively comprises a feedback control loop 34 that receives control inputs 34A from a joystick 1 and combines joystick control inputs 34A, which represent the velocity or acceleration vectors desired by the pilot. Joystick control inputs 34A are combined with vector feedback 34B in a vector difference calculator 34C to generate vector difference outputs 34D wherein vector feedback 34B represents measurements of the actual velocity or acceleration vectors of the vessel 2 and vector difference outputs 34D represent the current difference between the pilot command vessel 2 velocity or acceleration vectors and the current actual vessel 2 velocity or acceleration vectors.

As described herein above, a joystick controlled propulsion and maneuvering system 10 of the present invention may implement either or, preferably both, of a force command mode, wherein the system controls the acceleration vectors imposed on the vessel 2 by thrusters 24, engines 16 and rudders 22A, and a velocity command mode, wherein the system controls the velocity vector imposed on the vessel 2. For this reason, a presently preferred embodiment of the input loop 30 includes a force command processor 36A and a rate command processor 36B which respectively determine from vector difference outputs 36B maneuvering commands 36C and 36D respectively representing changes in the vessel 2 acceleration or velocity vectors necessary to achieve the velocity or acceleration vectors desired by the pilot.

As indicated in FIG. 3C, the selection between the force command mode and the force command mode is achieved by a first method selection switch 38A and a second method selection switch 38B wherein first method selection switch 38A selectively connects vector difference outputs 36B to one of force command processor 36A and rate command processor 36B. Second method selection switch 38B in turn connects the maneuvering commands 36C or 36D from force command processor 36A and rate command processor 36B to the input of the actuator loop 32.

Briefly considering force command processor 36A and rate command processor 36B in a presently preferred embodiment of a joystick controlled propulsion and maneuvering system 10, rate command processor 36B may be implemented as a optimal control system while force command processor 36A may be implemented as a convex optimization system, the principles and implementation of which are well known to those of ordinary skill in the arts and are well described in the arts. Exemplary descriptions of these subject matters may be found, for example, in Optimal Control and Estimation by R. F. Stengel, Courier Dover Publication, 1994 and Convex Optimization by S. P. Boyd and L. Vandenberghe, Cambridge University Press, 2004, and related discussions may be found, for example, in Guidance and Control of Oceam Vehicles by T. I. Fossen, Wiley, 1994 and in Identification of Dynamically Positioned Ships by T. I. Fossen, S. I. Sagatun and A. J. Sorenson, Control Engineering Practice, 4(3):369-376, 1996, all of which are incorporated herein by reference.

Continuing the description of the input loop 30, as shown the actuator loop 32 receives maneuvering commands 36C or 36D from force command processor 36A and rate command processor 36B and generates corresponding propulsion commands 40 to vessel propulsion system 42 which, as discussed above, may include thrusters 24, engines 16 and rudders 22A, to achieve the vessel acceleration or rate vectors desired by the pilot. The actuator loop 32 also generates appropriate feedback control signals 40A and 40B to force command processor 36A and rate command processor 36B, respectively, for use force by force command processor 36A and rate command processor 36B in respectively calculating maneuvering commands 36C or 36D. It will be noted that feedback control signals 40A and 40B are provided to force command processor 36A and rate command processor 36B through observer matrices 44A and 44B, respectively, which condition feedback control signals 44A and 44B and the information residing therein into forms suitable for use by force command processor 36A and rate command processor 36B, including extracted data or information from unwanted data or information. It will be understood, in this regard, that the signal conditioning performed by observer matrices 44A and 44B will be dependent upon the specific implementations of the actuator loop 32 and force command processor 36A and rate command processor 36B and may range from simple low or high pass filters to remove unwanted signal components to data processing methods to pre-condition numeric forms of data for force command processor 36A and rate command processor 36B.

Propulsion units 42 further include a variety of propulsion unit sensors 42S, such as shaft rpm sensors, angular position sensors and hydraulic fluid or oil temperatures, water flow rates, water pressures, and so on, that the detect the state operation or performance of the elements comprising propulsion units 42 and generate propulsion output signals 42P reflecting the performance of propulsion units 42 and the resulting forces and vectors operating on the vessel 2. As also shown, the input loop 32 further includes a plurality of navigational sensors 46, such as a GPS (global positioning system) unit, an inertial navigation unit, a compass, a tilt sensors, wind and current sensors, and so on, generating navigational output signals 46N indicating the navigational parameters or vectors of the vessel 2, such as vessel orientation and heading, vessel axial and lateral speeds, vessel axial and lateral accelerations, and so on, to describe the location and motions of the vessel 2.

As shown in FIG. 3B, propulsion output signals 42P and navigational output signals 46N are provided as inputs to a state estimation and sensor fusion unit 48, which process the information contained in or represented by propulsion output signals 42P and navigational output signals 46N into a form or forms appropriate for use by force command processor 36A and rate command processor 36B. Briefly, state estimation is the processing of propulsion output signals 42P and navigational output signals 46N to reduce or eliminate undesired data or signal components from propulsion output signals 42P and navigational output signals 46N, such as noise and unwanted frequency components, and to extract useful information and data to be forwarded to force command processor 36A and rate command processor 36B. As is well known in the arts, state estimation may take many forms, depending upon the nature and information or data content of the signals, the nature of the unwanted components, and the needs of the signal recipient or recipients, such as force command processor 36A and rate command processor 36B.

Sensor fusion, in turn, recognizes that the data from various sensors may overlap to a greater or lesser degree and “fuses”, or combines, such overlapping data to improve the quality of the resulting output data. Such data fusing may take the form, for example, of averaging overlapping data, selecting the most accurate or most likely accurate data, or eliminating the more questionable version of the data, and so on.

As shown in FIG. 3B, fused data output signals 48S from state estimation and sensor fusion unit 48 are provided as feedback inputs to force command processor 36A and rate command processor 36B for use in calculating maneuvering commands 36C or 36D and as vector feedback 34B to vector difference calculator 34C for use in generating vector difference outputs 34D. It will be noted that fused data output 48 is provided to force command processor 36A, rate command processor 36B and vector difference calculator 34C through observer matrices 44C, 44D and 44E which, as described above, condition, filter or otherwise process fused data output 48 and the information residing therein into forms suitable for use by force command processor 36A, rate command processor 36B and vector difference calculator 34C.

Next referring to FIG. 3C and the actuator loop 32, as described above the actuator loop 32 operates in a control space that is defined by and includes vessel 2, thrusters 24, engines 16 and rudders 22A, the physical characteristics and performances of the actual thrusters 24, engines 16 and rudders 22A and the actual physical motions and reactions of the physical vessel 2, including such factors as vessel 2 mass and dimensions and the effects of wind and currents. The input loop 30 thereby comprises an interface and translation between the pilot's desires, as expressed by the pilot through a joystick 1 as abstract acceleration and velocity vectors values and the actual, physical characteristics of vessel 2, thrusters 24, engines 16 and rudder(s) 22A, and the actual physical reality and characteristics of the vessel, thrusters, engines and rudder(s). Stated another way, and more briefly, the actuator loop 32 translates maneuvering commands 36C or 36D from force command processor 36A and rate command processor 36B into vessel propulsion commands 40 to vessel propulsion units 42 and controls vessel propulsion units 42 so as to achieve the vessel 2 acceleration or rate vectors desired by the pilot.

As shown in FIG. 3C, the actuator loop 32 is a feedback loop processor generally similar in structure to the input loop 30. The primary calculation processes in the actuator loop 32, that is, the operation necessary to translate maneuvering commands 36C or 36D into vessel propulsion commands 40 and to control vessel propulsion units 42 is performed by a inner control processor 50, which receives maneuvering commands 36C or 36D from force command processor 36A and rate command processor 36B and generates corresponding vessel control commands 50C according to dynamic models of vessel 2 and propulsion units 42 stored therein. As indicated, a presently preferred embodiment of an inner control processor 50 is comprised of a finite state machine 50F coupled and interacting with a proportional-integral-derivative control calculator 50P. In this regard, it will be appreciated that the specific design and operation of inner control processor 50, finite state machine 50F and proportional-integral-derivative control calculator 50P will typically be specific to the embodiment and implementation of the joystick controlled propulsion and maneuvering system 10, but are generally well known in the relevant arts and need not be described in further detail.

The actuator loop 32 will further include the command logic required to modify vessel control commands 50C according to the specific method and mode of operation currently being employed by the pilot, such as the acceleration or rate control methods and the normal, hold bearing, combined hold bearing and hold position and learning modes of operation. This functionality may be implemented in a smart command processor 52, as shown in FIG. 3C, which will receive vessel control commands 50C from inner control processor 50 and generate correspondingly modified vessel control commands 52C. It should be noted that smart command processor 52 may also be employed in the learning mode of operation to generate the dynamic models of vessel 2 and propulsion units 42 from the pilot joystick 1 control inputs and the measured vessel 2 responses and to store the dynamic models of vessel 2 and propulsion units 42 in inner control processor 50.

As shown, vessel control commands 52C from smart command processor 52 are provided to a corrections processor 54 which also receives “noise” inputs 541 comprised, for example, of certain of propulsion output signals 42P and navigational output signals 46N. Noise inputs 541 are selected signals that represent “noise” disturbances, such as environmental forces acting on the vessel 2 as a result of, for example, wind and waves. Corrections processor 54 corrects vessel control commands 52C of such noise disturbances, and generates and provides the final vessel propulsion commands 40 as described above.

As also shown, the actuator loop 32 includes connections to at least some of propulsion unit sensors 42S or equivalent connections to propulsion output signals 42P to receive indications of the operating states or performance factors of propulsion unit 42 elements that effect the generation of vessel propulsion commands 40, such as the outputs of rpm and hydraulic, cooling fluid or oil temperatures. As shown, the selected one of propulsion output signals 42P are provided to an actuator loop state estimation and sensor fusion unit 48I which, as discussed above, processes the information contained in or represented by the selected propulsion output signals 42P into a form or forms appropriate for use by the actuator loop 32. The resulting signal outputs are provided to the illustrated feedback connection to be combined with maneuvering commands 36C and 36D as inputs to inner control processor 50 and as feedback signals 40A and 40B to inputs of force command processor 36A and rate command processor 36B.

Lastly, and as illustrated in FIG. 2A, in a presently preferred embodiment of a joystick controlled propulsion and maneuvering system 10 each engine 16 is equipped with a slippable clutch 56 for low speed operation. In this regard, it must be noted that in a conventional marine engine and clutch system, and even if the engine is at idle, the vessel will generally be driven at a typical minimum speed range of four to five knots if the output propeller shaft is locked to the engine output shaft through the clutch. The provision of a slippable clutch 56 controlled by the joystick controlled propulsion and maneuvering system 10 will, however, circumvent this problem by allowing the clutch to be slipped in a range between some minimum and maximum amount to thereby permit the minimum low speed range of the vessel to be controllably reduced below the speed ranges that can be achieved by conventional clutch systems.

According to the present invention, the mode of clutch operation wherein the engines 16 are run at idle and the propeller thrust output is controlled by slipping the clutches 56 is referred to as “troll mode” while the mode of operation wherein the clutch is locked, or closed to engage the engine output shaft with the propeller shaft, is referred to as “lock-up mode”. Further in this regard, it must be noted that when operating in the troll mode and at a slip level above the maximum skip, which is less than 100%, the output shaft will not rotate and deliver power to the propeller and that it typically requires a small “bump”, or temporary decrease in slip, to initiate rotation of the propeller shaft. When operating at a slip level less than the minimum slip, the clutch will lock-up and it will typically be found that there is a gap in the range of speeds attainable between the toll mode and the lock-up mode. Vessel speeds in this gap may be achieved, however, by operating in either the “max-troll” or “engine follow up” mode wherein the clutch is controlled to a minimum slip greater than lock-up and the engines are run at speeds greater than idle. In a presently preferred embodiment of a joystick controlled propulsion and maneuvering system 10 the “troll”, “lock-up” and “max-troll” or “engine follow up” modes may, for example, be implemented in and through smart command processor 52, discussed above.

In conclusion, while the invention has been particularly shown and described with reference to preferred embodiments of the apparatus and methods thereof, it will be also understood by those of ordinary skill in the art that various changes, variations and modifications in form, details and implementation may be made therein without departing from the spirit and scope of the invention as defined by the appended claims.

1-13. (canceled)

14. A marine propulsion and steering system for a vessel comprising:
a vessel propulsion system, comprising:
a propulsion system for generating thrust vectors and controlling rotational and translational motion of the vessel, and
a maneuvering system comprising:
at least one joystick for generating propulsion and maneuvering control inputs representing vessel motions desired by a pilot, and
a maneuvering controller comprising:
an input loop and an actuator loop responsive to the propulsion and maneuvering control inputs for generating corresponding control outputs to the propulsion system for controlling axial, translational and rotational motions of the vessel in compliance with the propulsion and maneuvering control inputs,
wherein the input loop is responsive to the propulsion and maneuvering control inputs to generate maneuvering commands representing a magnitude and a direction of motion of the vessel desired by the pilot, and
the actuator loop is responsive to the maneuvering commands from the input loop to generate corresponding vessel control commands to at least one actuator of the vessel propulsion system to generate a propulsion and maneuvering force to cause the vessel to move in compliance with the propulsion and maneuvering control inputs; and
the actuator loop comprises:
an inner processor including a finite state machine interacting with a proportional-integral-derivative control calculator for receiving the maneuvering commands and generating corresponding vessel propulsion commands,
a command logic unit connected with the inner processor for modifying the vessel propulsion commands according to a current mode of operation of the maneuvering system to generate the propulsion commands for the at least one actuator,
a corrections processor connected with the command logic unit and receiving the modified propulsion commands and at least one input representing a disturbance exterior to and acting on the vessel and correcting the propulsion commands to eliminate the disturbance, and
an actuator loop state estimation and sensor fusion unit connected with at least one propulsion sensor for extracting propulsion unit information representing at least one operating state of the propulsion unit and providing a corresponding feedback signal to the actuator loop processor and to the input loop command processor.

15. The marine propulsion and steering system for a vessel according to claim 14, wherein the input loop comprises:
a vector difference calculator receiving the propulsion and maneuvering control inputs and a vector feedback and generating vector difference outputs of a command processor receiving the vector difference outputs and generating maneuvering commands selectively representing one of changes in a vessel acceleration vector and changes in a vessel velocity vector necessary to control the motions of the vessel in compliance with the propulsion and maneuvering control inputs,
a propulsion unit sensor for generating a propulsion sensor output representing a state of operation of at least one actuator.

16. The marine propulsion and steering system for a vessel according to claim 14, wherein operating modes of the maneuvering system include at least one of:
a normal mode in which the propulsion and maneuvering control inputs control all motions of the vessel, including vessel heading, vessel axial velocity or acceleration, and vessel rotation and direction of lateral acceleration or velocity,
a hold bearing mode in which a current bearing of the vessel are held constant while the propulsion and maneuvering control inputs control the axial and lateral velocity and acceleration of the vessel,
a hold position mode in which the axial and lateral acceleration and velocity of the vessel are held constant so that the vessel remains at a fixed position while the propulsion and maneuvering control inputs control the vessel bearing, and
a combined hold bearing and hold position mode in which the vessel bearing, rotation and position are held constant.

17. The marine propulsion and steering system for a vessel according to claim 14, wherein:
the propulsion system includes at least one engine,
the at least one engine includes a slippable clutch controlled by the maneuvering system and connected between an output shaft of the at least one engine and at least one propeller shaft,
and the modes of operation of the maneuvering system further include
a lock-up mode wherein the clutch is engaged to couple the engine output shaft to the at least one propeller shaft,
a troll mode in which the engine is operated in an idling state and the clutch is slippingly engaged between the engine output shaft to the at least one propeller shaft, and
an engine follow up mode in which the clutch is controlled to a minimum slip slightly above lock-up and the engine is run at a speed greater than idling.

18. The marine propulsion and steering system for a vessel according to claim 14, further comprising:
an axial propulsion system including at least one engine responsive to the actuator loop for controlling axial motion of the vessel.

19. The marine propulsion and steering system for a vessel according to claim 14, further comprising:
the propulsion system includes at least one actuator for generating at least one thrust vector for controlling magnitude and direction of motion of the vessel and wherein the at least one actuator includes at least one of an engine and at least one rudder and at least one thruster and at least one steerable thruster and at least a second engine.

20. The marine propulsion and steering system for a vessel according to claim 14, wherein:
the maneuvering controller is responsive to the propulsion and maneuvering control inputs for concurrently controlling axial, translational and rotational motions of the vessel in compliance with the propulsion and maneuvering control inputs.

21. A method for controlling a vessel propulsion system including at least one joystick for providing a corresponding motion control command to the vessel propulsion system, a propulsion system for generating thrust vectors for controlling rotational and translational motion of the vessel, a maneuvering controller including an input loop and an actuator loop responsive to propulsion and maneuvering control inputs for generating corresponding control outputs to the propulsion system to control axial, translational and rotational motions of the vessel in compliance with the propulsion and maneuvering control inputs, the input loop being responsive to the propulsion and maneuvering control inputs to generate maneuvering commands representing a magnitude and direction of motion of the vessel desired by the pilot, the actuator loop being responsive to the maneuvering commands from the input loop to generate corresponding vessel control commands to at least one actuator of the vessel propulsion system to generate propulsion and maneuvering forces to cause the vessel to move in compliance with the propulsion and maneuvering control inputs; and the actuator loop comprises an inner processor including a finite state machine interacting with a proportional-integral-derivative control calculator for receiving the maneuvering commands and generating corresponding vessel propulsion commands, a command logic unit connected from the inner processor to modify the vessel propulsion commands according to a current mode of operation of the maneuvering system to generate the propulsion commands to the at least one actuator, a corrections processor connected from the command logic unit and receiving the modified propulsion commands and at least one input representing a disturbance exterior to and acting on the vessel and correcting the propulsion commands to eliminate the disturbance, and an actuator loop state estimation and sensor fusion unit connected from at least one propulsion sensor for extracting propulsion unit information representing at least one operating state of the propulsion unit and providing a corresponding feedback signal to the actuator loop processor and to the input loop command processor; the method comprising the steps of:
selecting a mode of operation from at least one of a normal mode of operation, a hold bearing mode of operation, a hold position mode of operation and a combined hold bearing and hold position mode of operation, and
when in the normal mode of operation,
controlling all heading, axial motion, rotation and lateral motion of the vessel by corresponding joystick control inputs,
when in the hold bearing mode of operation,
holding constant a current bearing of the vessel and controlling axial and lateral motion of the vessel by corresponding joystick inputs,
when in the hold position mode of operation,
holding constant a current position of the vessel and controlling vessel bearing by corresponding joystick inputs, and
when in the combined hold bearing and hold position mode of operation,
holding constant a current vessel bearing and position.

22. The method according to claim 21 for controlling a vessel propulsion system, further comprising the step of providing the vessel propulsion system with at least one actuator for generating at least one thrust vector for controlling a magnitude and a direction of motion of the vessel, and
having the at least one actuator include at least one of:
at least a first engine,
at least one rudder,
at least one thruster,
at least one steerable thruster, and
at least a second engine.

23. A method for controlling a vessel propulsion system wherein the input device includes at least one joystick for providing a corresponding motion control command to the vessel propulsion system, a maneuvering controller including an input loop and an actuator loop responsive to propulsion and maneuvering control inputs for generating corresponding control outputs to the propulsion system to control axial, translational and rotational motions of the vessel in compliance with the propulsion and maneuvering control inputs, the input loop being responsive to the propulsion and maneuvering control inputs to generate maneuvering commands representing a magnitude and direction of motion of the vessel desired by the pilot, the actuator loop being responsive to the maneuvering commands from the input loop to generate corresponding vessel control commands to at least one actuator of the vessel propulsion system to generate propulsion and maneuvering forces to cause the vessel to move in compliance with the propulsion and maneuvering control inputs; and the actuator loop comprises an inner processor including a finite state machine interacting with a proportional-integral-derivative control calculator for receiving the maneuvering commands and generating corresponding vessel propulsion commands, a command logic unit connected from the inner processor to modify the vessel propulsion commands according to a current mode of operation of the maneuvering system to generate the propulsion commands to the at least one actuator, a corrections processor connected from the command logic unit and receiving the modified propulsion commands and at least one input representing a disturbance exterior to and acting on the vessel and correcting the propulsion commands to eliminate the disturbance, and an actuator loop state estimation and sensor fusion unit connected from at least one propulsion sensor for extracting propulsion unit information representing at least one operating state of the propulsion unit and providing a corresponding feedback signal to the actuator loop processor and to the input loop command processor; and the at least one actuator includes at least one of: at least one engine, at least one rudder, at least one thruster and at least one steerable thruster, the method comprising the steps of:
when in a basic propulsion mode of operation,
generating vessel axial motion commands upon corresponding motions of the joystick,
generating vessel rotation commands upon corresponding rotational motions of the joystick,
entering a maneuvering mode of operation upon a lateral motion of the joystick, and
entering a drive mode of operation when a motion of the joystick generating axial motion commands exceeds a drive mode set point,
when in the maneuvering mode of operation,
generating vessel lateral motion commands upon corresponding lateral motions of the joystick,
generating vessel axial motion commands upon corresponding motions of the joystick exceeding a drive mode set point, and
when in the drive mode of operation
generating from the joystick vessel axial motion commands upon corresponding motions of the joystick, and
generating from the joystick at least one of rudder steering commands and first and second engine steering commands upon corresponding lateral motions of the joystick.

24. The method according to claim 23 for controlling a vessel propulsion system further comprising the step of providing the propulsion system with at least one actuator for generating at least one thrust vector for controlling a magnitude and a direction of the emotion of the vessel, and the at least one actuator includes at least an engine and at least one of:
at least one rudder,
at least one thruster,
at least one steerable thruster, and
at least a second engine.

25. The method according to claim 23 for controlling a vessel propulsion system, further comprising the step of:
having the maneuvering controller be responsive to the propulsion and maneuvering control inputs for concurrently controlling axial, translational and rotational motion of the vessel in compliance with the propulsion and maneuvering control inputs.
